(19) United States
(12) Patent Application Publication
(10) Pub. No.: US 2008/0072828 A1
(43) Pub. Date: Mar. 27, 2008

(54) Treat holder with customized treats

(76) Inventor: Camilla R. Beck, Longmont, CO (US)

Correspondence Address: Camilla R. Beck, 644 Bowen Street, Longmont, CO, 80501, US

(21) Appl. No.: 11/903,811

(22) Filed: Sep. 25, 2007

Related U.S. Application Data
(60) Provisional application No. 60/846,851, filed on Sep. 25, 2006.

(51) Int. Cl. A01K 15/00

(52) U.S. Cl. 119/51.01

(57) ABSTRACT

A portable, reusable treat holder and dispensing device with customized treats, comprised of a clasp joined to one end of a flexible cord that has a figure eight formed at its opposite end, designed for use with its own treats which have a hole in them. Treats are strung onto the holder by threading the figure eight at end of the cord through the hole in each treat. As the collapsible figure eight passes completely through the hole it regains its shape and acts like a stopper, thereby fastening treats onto the cord. Treats stack neatly on top of each other, ready for dispensing. Treats are split in half between the user's thumb and first two fingers, dispensing two rewards at once in a discreet, single-handed motion. The clasp enables the holder to be attached to the user's person, clothing, bags, and other permissible surfaces and objects.

### CROSS-REFERENCE TO RELATED APPLICATIONS

This application claims the benefit of provisional patent application Ser. No. 60/846,851 filed Sep. 25, 2006 by the present inventor.

### FEDERALLY SPONSORED RESEARCH

Not applicable

### SEQUENCE LISTING OR PROGRAM

Not applicable

### BACKGROUND OF THE INVENTION

1. Field of Invention

This invention relates to devices used for the rewarding and training of animals, specifically a portable, reusable treat holder with customized treats which enables the user to dispense rewards in a discreet and efficient manner.

2. Prior Art

Animal handlers can use treats to reward pets after desired behaviors, with the reward being given directly after the behavior is completed. This process creates the need for a handy treat holder that provides treats to the user in a quick and inconspicuous manner. In addition, when one is walking, hiking, or performing other physical activities with pets, it is often considered necessary to take along treats. This creates the need to have a lightweight, tidy, and easy-to-use treat holder at hand.

Heretofore a number of patents have disclosed treat holders and training assist devices for animals, including: U.S. Pat. No. 5,499,403 to Harrigan, issued Mar. 19, 1996 (a disposable stick-on pocket); U.S. Pat. No. 7,143,719 to Giddens et al., issued Dec. 5, 2006 (a wearable canister with clicker); U.S. Pat. No. 7,175,069 to Tsengas, issued Feb. 13, 2007 (a wearable pliable pouch); U.S. Pat. No. 6,722,317 to O'Rourke, issued Apr. 20, 2004 (a wearable pliable pouch with bell); U.S. Pat. No. 7,028,640 to Cummings, issued Apr. 18, 2006 (a tube with thumb trigger dispenses directly to animal); U.S. Pat. No. 7,004,111 to Olson, issued Feb. 28, 2006 (a tube worn on the forearm); U.S. Pat. No. 6,988,464 to Rutledge, issued Jan. 24, 2006 (a wall-mounted machine with hand crank).

These prior art methods have general disadvantages including inconvenience and difficulty in using and/or transporting the devices. More specifically, these methods possess their own individual shortcomings:

(a) A disposable, stick-on pocket can be wasteful and may alter the surface of some fabrics;

(b) Large, wearable canisters and pouches with bells and clickers can be clunky and a consumer may not want a noisemaker that won't be used for their treating and training purposes;

(c) A device that dispenses treats directly to the animal is not desired by the user who wants to administer the treat directly from his/her hand;

(d) In the case of awkward equipment that is strapped to a body part such as the forearm, many consumers do not want to go to that much trouble, nor do they want to wear an unwieldy apparatus while training animals or recreating with their pets;

(e) Wall-mounted machines that dispense treats with a hand crank are stationery and therefore, not portable.

### BRIEF SUMMARY OF THE INVENTION—GENERAL IDEA

In accordance with the present invention, a treat holder with customized treats comprises a ropelike cord means and an edible animal reward with a hole through it for stringing treats axially along the length of the cord.

More uniquely, the present invention comprises a clasp joined to a flexible cord, for use as a reusable holder and dispensing device for containing and transporting animal treats. This device is meant to be used with customized treats that have a hole in them. The bottom end of the cord is formed into a flexible figure eight which collapses when pushed into the hole in a treat. When the cord end passes completely through the hole it regains its shape and acts like a stopper, thereby securing treats on the cord. Loaded treats stack neatly along the cord, one on top of another. Bite-sized rewards are dispensed two at a time, as the user manually splits a treat in half using a subtle, single-handed motion. The device is meant to be attached to the user's person, clothing, backpack, or any other permissible surface or object, so that treats are close at hand and ready to be dispensed.

### BRIEF SUMMARY OF THE INVENTION—ADVANTAGES

From the description above, a number of advantages of my treat holder with customized treats becomes evident:
(a) When compared to pre-existing treat containers that aid in the rewarding of animals, the present invention attaches to a larger variety of surfaces and objects and provides a lighter, quieter alternative to ungainly noisemakers like canisters, pouches, and purses;
(b) The simplified use and inconspicuous design of this treat holder is less obtrusive to the training and treating process than other devices that require cumbersome equipment strapped to the body, or bulky containers clipped to a belt loop or strung around the neck;
(c) Treats are neatly contained and result in minimal crumbs, providing an imperceptible and tidy alternative to messy treat containers that can draw unwanted attention and retain crumbs and odors;
(d) Other devices dispense only a single treat at a time or an indeterminate number of treats at once, while the present invention enables the user, in one discreet motion, to dispense into his/her hand two bite-sized rewards from one treat;
(e) Unlike devices that fully enclose their contents, a visual or tactile tally of remaining treats can be done easily on this device without making distracting shaking noises, or forcing the user to noticeably open the device and look into it, or to squeeze a lumpy pouch and guess how many treats are left inside.

### BRIEF SUMMARY OF THE INVENTION—OBJECTS

The present invention is intended for use in the storing and dispensing of treats, to train and reward animals. Its design and method enable treats to be portable, neat, inconspicuous, and close at hand, while promoting improved training and treating efficacy.

Accordingly, besides the objects of the holders described in my above patent, several objects of the present invention are:

(a) to offer solutions to the above mentioned shortcomings and drawbacks of the prior art;

(b) to provide a portable, reusable animal treat holder and dispensing device that uses treats with a hole in the middle which are strung onto a cord, in a form that is practical and easy to manufacture and to use;

(c) to be lightweight, quietly operated, and inconspicuous in its design;

(d) to be easily attached to and removed from the user's person or clothing (waistband, belt loop, jacket zipper pull, shirt pocket, etc.) or clipped to a backpack or purse or any other permissible surface or object using a clasp, or hung around the user's neck by attaching the clasp to a chain or something similar;

(e) to use a treat with a hole in it for stringing onto a cord or cable or other similar material;

(f) to be easy to load, to keep treats neatly stacked, and to enable such treats to be easily dispensed;

(g) to be easily operated with one hand, by right- and left-handed users;

(h) to enable the user, in one discreet motion, to dispense into his/her hand two bite-sized rewards from a single treat;
(i) to use a treat that is durable when contained, yet breaks in half easily and consistently when proper pressure is applied and which results in minimal crumbs when dispensed;

(j) to enable the user to easily see and/or feel how many treats are on the holder;

(k) to be used by animal handlers or others wanting to reward an animal;

(l) to be unobtrusive to the training and treating process;

(m) to keep treats out of the animal handler's pockets and mouth;

(n) to enable animal handlers to wear clothing without pockets and still have treats neatly stowed on their person, by attaching the treat holder to a garment worn under a sweater or sport coat, or attached to the waistband and hidden under the flaps of a jacket or shirt;

(o) to use a treat that avoids staining garments or surfaces;

(p) to require little to no clean up or assembly.

### BRIEF DESCRIPTION OF THE VIEWS OF THE DRAWING—FIGURES

FIG. 1 is a front elevational view of the treat holder;

FIG. 2 is a top plan view of a customized treat for use with the treat holder.

DRAWINGS - REFERENCE NUMERALS

| | | | |
|---|---|---|---|
| 10 | holder | 12 | clasp |
| 14 | cord | 16 | cord loop joining cord to clasp |
| 18 | opening at bottom | 20 | crimping beads securing |
| | end of clasp | | cord loop to clasp |
| 22 | figure eight at bottom | 24 | crimping bead securing |
| | end of cord | | figure eight |
| 26 | customized treat | 28 | hole in customized treat |

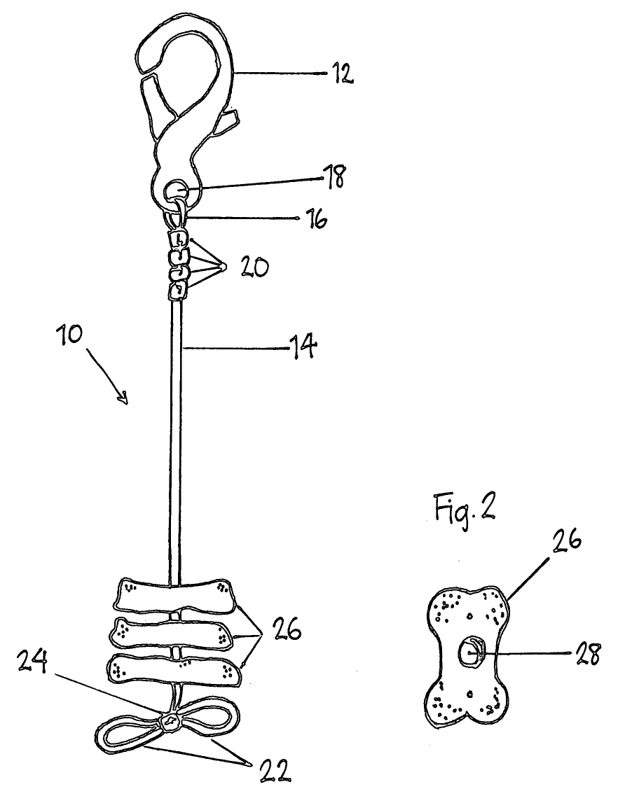

### DETAILED DESCRIPTION—FIGS. 1 AND 2—PREFERRED EMBODIMENT

A preferred embodiment of the treat holder, 10, is illustrated in FIG. 1 (elevational view) and FIG. 2 (top plan view). The present invention is designed to provide a portable, reusable animal treat holder and dispensing device, 10, with customized treats, 26, capable of being securely and temporarily attached to the user's person, clothing, backpack, or other permissible surfaces or objects, and capable of holding multiple treats, 26, and of dispensing two bite-sized rewards at a time, upon demand of the user. The invention is intended to be used by anyone who does not want to carry around loose treats when they are training or showing animals or recreating with pets. The present invention is intended to provide users with a lightweight, tidy, and more efficient alternative to the prior art.

Generally, the treat holder, 10, includes a clasp, 12, attached to a cord, 14, with a flexible figure eight, 22, at its bottom end, and treats, 26, with a hole, 28, in them for stringing onto the cord, 14. Many different metal or plastic connector findings could be used for the clasp, 12, such as a spring clip or a lanyard hook, a bolt snap or a snap hook, a lobster clasp or other suitable connector finding. The flexible ropelike cord, 14, could be composed of a variety of similar materials such as cable or string, a thread or line of some sort, as well as nylon-coated wire or other material that could act as an axis along which treats, 26, are contained. The animal treat, 26, could be produced in any shape that results in the dispensing of two equal rewards when manually split in half by the user and removed from the cord, 14.

In FIG. 1 the treat holder, 10, comprises a clasp, 12, joined to the top end of the cord, 14, via a cord loop, 16, threaded through the opening, 18, at the bottom end of the clasp, 12, and fastened to itself with crimping beads, 20. The bottom end of the cord, 14, is then looped twice into the shape of a figure eight, 22, and secured with a crimping bead, 24. In FIG. 2 a hole, 28, is drilled through the center of each treat, 26, for threading onto the cord, 14.

### Operation—FIG. 1

The first step in utilizing the treat holder, 10, is to place treats, 26, on the cord, 14. This is done by pinching flat the loops of the figure eight, 22, and pushing it completely through the hole, 28, in a treat, 26. After both loops of the figure eight, 22, pass completely through the hole, 28, it expands to regain its original shape, acting as a stopper and thereby locking the treats, 26, onto the cord, 14. Treats, 26, sit neatly stacked on the cord, 14, one on top of the other (shown in FIG. 1) until the user is ready to dispense a reward. Once loaded with treats, 26, the device, 10, is ready for use.

The treat holder, 10, can be attached wherever it is handy to have treats, 26, within reach. The clasp, 12, allows the treat holder, 10, to be temporarily attached to the user's person, clothing, bags, or other permissible surfaces or objects so that treats, 26, are always handy, organized and ready to go. Hook both ends of the holder, 10, together (attach the clasp, 12, to a loop of the figure eight, 22,) and the device can be worn around the wrist like a bracelet and still remain accessible to the user's opposite hand.

When ready to dispense a reward, the user grips the treat, 26, resting at the bottom of the stack between the thumb and first two fingers and applies pressure. The treat, 26, then splits neatly in half, resulting in two bite-sized rewards from one treat, 26, delivered in a subtle, single-handed motion. To reload the holder, 10, the user simply threads additional treats, 26, onto the cord, 14.

I claim:

1. In an animal treat holder with customized treats of the type comprising a ropelike cord means and a treat with a hole through it, the improvement wherein said treat contains said hole for allowing said cord to pass through its center, and said cord contains said treats axially along its length.

2. The treat holder of claim 1 wherein a connector finding means is joined to said cord for temporary attachment to the user's person, clothing, backpack, and other permissible surfaces and objects.

3. The treat holder of claim 1 wherein an end of said cord comprises a collapsible means for passing through said hole in said treat, to then regain its shape and thereby act as a stopper means for fastening said treats onto said cord.

4. A method of containing animal treats, comprising:
(a) providing a treat holder of the type comprising said ropelike cord means,
(b) providing a customized treat of the type comprising said treat with said hole through it,
(c) threading said cord through said hole in said treat,
whereby said treats are threaded onto said cord and stored axially along its length, for containment and portability.

5. A method of dispensing animal treats, comprising:
(a) providing said treats strung axially along the length of said ropelike cord means,
(b) applying pressure to said treat so that it breaks in half and is removed from said cord,
whereby said treat produces two separate rewards into the user's hand.
